(19) United States
(12) Patent Application Publication
(10) Pub. No.: US 2025/0091159 A1
(43) Pub. Date: Mar. 20, 2025

(54) SEMI-CLOSED LOCAL LOW-VACUUM LASER WELDING DEVICE AND WELDING METHOD

(71) Applicant: HARBIN WELDING INSTITUTE LIMITED COMPANY, Harbin, Heilongjiang (CN)

(72) Inventors: Ruisheng HUANG, Harbin, Heilongjiang (CN); Jipeng ZOU, Harbin, Heilongjiang (CN); Jian CHEN, Harbin, Heilongjiang (CN); Bin TENG, Harbin, Heilongjiang (CN); Pengbo WU, Harbin, Heilongjiang (CN); Xin NIE, Harbin, Heilongjiang (CN); Xiaomei LIANG, Harbin, Heilongjiang (CN); Hao CAO, Harbin, Heilongjiang (CN); Naiwen FANG, Harbin, Heilongjiang (CN)

(73) Assignee: HARBIN WELDING INSTITUTE LIMITED COMPANY, Harbin, Heilongjiang (CN)

(21) Appl. No.: 18/579,749

(22) PCT Filed: Nov. 14, 2023
(86) PCT No.: PCT/CN2023/131379

§ 371 Date: Jan. 16, 2024

(30) Foreign Application Priority Data
May 23, 2023 (CN) 202310587579.5

(51) Int. Cl. B23K 26/12; B23K 26/06; B23K 26/24; B23K 26/70

(52) U.S. Cl. CPC B23K 26/1224; B23K 26/0648; B23K 26/24; B23K 26/702

(57) ABSTRACT

A semi-closed local low-vacuum laser welding device and welding method is provided. The semi-closed local low-vacuum laser welding device includes a local low-vacuum cabin, a dynamic sealing structure, a mechanical pump, and a laser welding mechanism. The local low-vacuum cabin includes a primary vacuum chamber, a secondary vacuum chamber and a tertiary vacuum chamber which are arranged in sequence, and a plate to be welded is arranged at a bottom of the primary vacuum chamber. The dynamic sealing structure is arranged at the bottom of the primary vacuum chamber, and the dynamic sealing structure is configured for connecting the primary vacuum chamber with the plate to be welded. The mechanical pump is in communication with the primary vacuum chamber and the secondary vacuum chamber. The laser welding mechanism is arranged corresponding to the local low-vacuum cabin, and is configured for welding the plate to be welded.

### CROSS-REFERENCE TO RELATED APPLICATION

This patent application is a national stage application of International Patent Application No. PCT/CN2023/131379, filed on Nov. 14, 2023, which claims priority of Chinese Patent Application No. 202310587579.5, filed on May 23, 2023, both of which are incorporated by references in their entities.

### TECHNICAL FIELD

The present disclosure relates to the technical field of laser material processing, in particular to a semi-closed local low-vacuum laser welding device and welding method.

### BACKGROUND

With the continuous improvement of the usage indexes and technical indexes of thick-walled components for major equipment in aerospace and marine engineering, higher requirements are put forward for the connection methods of structural components. At present, arc welding and electron beam welding methods are widely used for the welding of thick plate materials. Multilayer and multipass arc welding has slow welding speed, low efficiency, high heat input, and significant residual stress and deformation of joints. Vacuum electron beam welding is an ideal welding method, in which the welding penetration on the order of hundred millimeters can be achieved in a single pass to obtain high-quality weld seams. However, the thick-walled components are generally large in overall dimension, there are big problems in economy and applicability of constructing a huge vacuum chamber, so that the application fields are greatly limited. At present, there is an urgent need for an efficient, energy-saving, and high-quality welding method to upgrade the manufacturing level of large-scale components.

Laser welding technology, as a green manufacturing technology in the 21st century, has been widely used. With the increasing requirements for welding thickness, quality and efficiency, traditional laser welding technologies are subjected to innovation and development. The biggest problem of the traditional laser welding technologies is that the produced plasma/metal vapor groups have strong absorption, scattering, reflection and other loss effects on incident laser under ultra-high power laser conditions, which easily cause various welding defects, such as splashing, air holes, shrinkage cavity and surface collapse, so that it is difficult to apply ultra-high power laser in practical engineering.

### SUMMARY

Therefore, the technical problem to be solved by the present disclosure is to overcome the problem in the prior art that the produced plasma/metal vapor groups have strong absorption, scattering, reflection and other loss effects on incident laser under ultra-high power laser conditions, which easily cause various welding defects, such as splashing, air holes, shrinkage cavity and surface collapse, so as to provide a semi-closed local low-vacuum laser welding device and welding method.

In order to solve the above technical problem, a semi-closed local low-vacuum laser welding device is proposed in the present disclosure. The semi-closed local low-vacuum laser welding device includes a local low-vacuum cabin, a dynamic sealing structure, a mechanical pump, and a laser welding mechanism. The local low-vacuum cabin includes a primary vacuum chamber, a secondary vacuum chamber, and a tertiary vacuum chamber which are arranged in sequence, a plate to be welded is arranged at a bottom of the primary vacuum chamber. The dynamic sealing structure is arranged at the bottom of the primary vacuum chamber, and the dynamic sealing structure is configured for connecting the primary vacuum chamber with the plate to be welded. The mechanical pump is in communication with the primary vacuum chamber and the secondary vacuum chamber. The laser welding mechanism is arranged corresponding to the local low-vacuum cabin and configured for welding the plate to be welded.

Furthermore, the dynamic sealing structure includes a base, a fixing plate, and a fixing ring, the base is arranged at the bottom of the primary vacuum chamber, and a sealing element is sleeved on the base; the fixing plate is arranged on the base and abuts against a side of the sealing element; and the fixing ring is sleeved on the base and abuts against another side of the sealing element, and the fixing ring and the fixing plate are configured for limiting a moving position of the sealing element.

Furthermore, the sealing element includes double sealing rings and a fixing block, the double sealing rings are arranged on the base; and the fixing block is located between the double sealing rings, and the fixing block is configured for supporting the double sealing rings.

Furthermore, the dynamic sealing structure further includes multiple supporting members, and the multiple supporting members are arranged at intervals along a bottom of the base.

Furthermore, the semi-closed local low-vacuum laser welding device further includes a primary deposition plate and a secondary deposition plate, the primary deposition plate is arranged between the primary vacuum chamber and the secondary vacuum chamber, and a primary deposition hole is formed in the primary deposition plate; and the secondary deposition plate is arranged between the secondary vacuum chamber and the tertiary vacuum chamber, and a secondary deposition hole is formed in the secondary deposition plate.

Furthermore, a diameter of an end of the primary deposition hole is larger than a diameter of another end of the primary deposition hole, and a diameter of an end of the secondary deposition hole is larger than a diameter of another end of the secondary deposition hole.

Furthermore, gas extraction interface is formed on the primary vacuum chamber, and the mechanical pump is in communication with the gas extraction interface through a gas extraction pipeline.

Furthermore, the tertiary vacuum chamber further includes a lens, a gas suction port and a gas blowing port, the laser welding mechanism is arranged corresponding to the lens; the gas suction port and the gas blowing port are formed at both sides of the tertiary vacuum chamber, the gas suction port is in communication with the mechanical pump through the gas extraction pipeline, and the gas blowing port is connected with an argon gas source.

Furthermore, the laser welding mechanism includes a laser, a transmission fiber, and a laser processing head. The transmission fiber is configured for connecting the laser with the laser processing head. The laser processing head is arranged corresponding to the lens.

The present disclosure also provides a welding method of a semi-closed local low-vacuum laser welding device, including: turning on the mechanical pump to vacuum the local low-vacuum cabin until an environmental pressure is maintained to a required working pressure to realize dynamic balance; and turning on the laser welding mechanism, outputting laser light to pass through the tertiary vacuum chamber, the secondary vacuum chamber and the primary vacuum chamber in sequence from a top of the local low-vacuum cabin, and apply on the plate to be welded to form weld seams.

The technical solution of the present disclosure has the following advantages.

Firstly, the semi-closed local low-vacuum laser welding device provided in the present disclosure includes a local low-vacuum cabin, a dynamic sealing structure, a mechanical pump, and a laser welding mechanism. The local low-vacuum cabin includes a primary vacuum chamber, a secondary vacuum chamber, and a tertiary vacuum chamber which are arranged in sequence, and a plate to be welded is arranged at a bottom of the primary vacuum chamber. The dynamic sealing structure is arranged at the bottom of the primary vacuum chamber, and the dynamic sealing structure is configured for connecting the primary vacuum chamber with the plate to be welded. The mechanical pump is in communication with the primary vacuum chamber and the secondary vacuum chamber. The laser welding mechanism is arranged corresponding to the local low-vacuum cabin, and is configured for welding the plate to be welded.

Through the arrangement of the mechanical pump, the connection between the mechanical pump and the local low-vacuum cabin is realized, so that the primary vacuum chamber, the secondary vacuum chamber, and the tertiary vacuum chamber can be in a vacuum environment. Meanwhile, since the dynamic sealing structure is arranged at the bottom of the vacuum chamber, the connection between the primary vacuum chamber and the plate to be welded is realized through the dynamic sealing structure. The plate to be welded needs to be moved by a movement mechanism in the practical welding process, the plate to be welded can be welded by a laser welding structure, therefore, the semi-closed welding of the local low-vacuum cabin is realized.

The semi-closed local low-vacuum laser welding device combines the advantages of both laser welding and electron beam welding, and “vacuum environment” and “semi-closed welding” are combined to form a local vacuum structure, so that the size of components is no longer restricted by the vacuum chamber, while high-quality deep penetration welding of thick plate materials is realized.

The semi-closed local low-vacuum laser welding device is simple in structure, high in operability, and low in cost. Parts can be replaced in time when damaged. High-quality welding of large-size thick-walled components is realized at low cost.

The laser welding environment is changed from atmosphere to vacuum. It is found that laser welding in vacuum environment can obtain high-quality weld seams similar to those during electron beam welding, and the vacuum degree of the vacuum environment required during the laser welding is much lower than that during electron beam welding, and no ray radiation is produced in the welding process, so that it is possible to form a local low-vacuum environment only in some areas of the welding position for laser welding. The local vacuum environment formed above the welding area can suppress the production of plasma/metal vapor groups, so that the welding defects are reduced, and the welding quality is improved. Furthermore, the size of a workpiece to be welded is no longer restricted by the volume of the vacuum chamber. Therefore, the exploration of semi-closed local vacuum laser welding equipment and welding method has important theoretical significance and practical value.

As a kind of clean energy, laser is high in energy utilization when applied in welding field, and the welding pollution is small, so unlike in are welding, a few polluting smoke and dust is produced, and unlike in vacuum electron beam welding, no X-ray radiation is produced. The welding process is carried out in a semi-closed negative-pressure cabin, a part of the metal vapor produced in welding is adhered to an inner surface of the negative-pressure cabin, a part of the metal vapor produced in welding is collected by the gas extraction device, and thus the metal vapor cannot diffuse into the air to cause pollution to the environment and damages to the health of welding personnel.

Secondly, according to the semi-closed local low-vacuum laser welding device provided in the present disclosure, the dynamic sealing structure includes a base, a fixing plate, and a fixing ring. The base is arranged at the bottom of the primary vacuum chamber, and a sealing element is sleeved on the base. The fixing plate is arranged on the base and abuts against a side of the sealing element. The fixing ring is sleeved on the base and abuts against another side of the sealing element. The fixing ring and the fixing plate are configured for limiting a position of the sealing element. Because the base is arranged at the bottom of the vacuum chamber, a mounting position is provided for the sealing element. Furthermore, because the fixing plate and the fixing ring are arranged at both sides of the sealing element on the base, and the fixing ring is sleeved on an outer wall of the base, that is, the fixing ring is arranged on an outer wall of the sealing element, to support the sealing element from the outside, the fixing plate is arranged on an inner wall of the sealing element to support the sealing element from the inside, the fixing ring and the fixing plate support the sealing element from both sides of the sealing element, so that the sealing element is prevented from shifting when the plate to be welded is moved, and a vacuum environment between the vacuum chamber and the plate to be welded is ensured.

Thirdly, according to the semi-closed local low-vacuum laser welding device provided in the present disclosure, the sealing element includes double sealing rings and a fixing block. The double sealing rings are arranged on the base. The fixing block is located between the double sealing rings, and the fixing block is configured for supporting the double sealing rings. The arrangement of the double sealing rings has the effect of double-layer sealing, and fully ensures that the local low-vacuum cabin is always in a vacuum environment. Meanwhile, the fixing block located between the double sealing rings can effectively support the double sealing rings between the double sealing rings. The fixing block, the fixing ring and the fixing plate together constitute a supporting structure for the double sealing rings, so that good dynamic sealing performance can still be maintained in the local low-vacuum cabin during welding and moving.

Fourthly, according to the semi-closed local low-vacuum laser welding device provided in the present disclosure, the dynamic sealing structure further includes multiple supporting members, and the multiple supporting members are arranged at intervals along a bottom of the base.

The summary of the present disclosure is provided to introduce the selection of concepts in a simplified form, and is further described in the detailed description below. The summary of the present disclosure is neither intended to identify important or necessary features of the present disclosure, nor to limit the scope of the present disclosure.

### BRIEF DESCRIPTION OF THE DRAWINGS

In order to illustrate the technical solutions in the embodiments of the present disclosure or in the prior art more clearly, the attached figures required in the description of the embodiments or the prior art are simply described. Apparently, the embodiments in the following description are merely a part rather than all of the embodiments of the present disclosure. For those skilled in the art, other attached figures further can be obtained from these attached figures without creative efforts.

FIG. 1 is a schematic diagram of a semi-closed local low-vacuum laser welding device according to an embodiment of the present disclosure;

FIG. 2 is a section view of a local low-vacuum cabin of a semi-closed local low-vacuum laser welding device according to an embodiment of the present disclosure;

FIG. 3 is a sectional view of a semi-closed local low-vacuum laser welding device taken along a line B-B in FIG. 2 according to an embodiment of the present disclosure;

FIG. 4 shows the welding effect of a laser welding device under an atmospheric pressure; and

FIG. 5 shows the welding effect of a semi-closed local low-vacuum laser welding device according to an embodiment of the present disclosure.

### REFERENCE SIGNS IN ATTACHED FIGURES

1 local low-vacuum cabin; II primary vacuum chamber; Ill gas extraction interface; 112 observation window; 12 secondary vacuum chamber; 13 tertiary vacuum chamber; 131 lens; 132 gas suction port; 133 gas blowing port; 2 plate to be welded; 3 dynamic sealing structure; 31 base: 32 sealing element; 321 double sealing rings: 322 fixing block; 33 fixing plate; 34 fixing ring; 35 supporting member; 4 mechanical pump; 41 gas extraction pipeline; 5 laser welding mechanism; 51 laser; 52 transmission fiber; 53 laser processing head; 6 primary deposition plate; 61 primary deposition hole; 7 secondary deposition plate; 71 secondary deposition hole; 8 O-shaped sealing ring; and 9 bolt.

### DETAILED DESCRIPTION OF THE EMBODIMENTS

In the following, only some exemplary embodiments are simply described. It can be recognized by those skilled in the art that the described embodiments can be modified in various different ways without departing from the spirit or scope of the present disclosure. Therefore, the attached figures and description are considered to be exemplary in nature, rather than restrictive.

In the description of the present disclosure, it should be understood that the orientation or positional relationship indicated by the terms such as “center”, “longitudinal”, “transverse”. “length”, “width”, “thickness”, “upper”, “lower”, “front”, “rear”, “left”, “right”, “vertical”, “horizontal”, “top”, “bottom”, “inside”, “outside”, “clockwise” and “anti-clockwise” is based on the orientation or positional relationship illustrated in attached figures only for facilitating the description of the present disclosure and simplifying the description rather than indicating or implying that the indicated device or element must be in a specific orientation and is constructed and operated in the specific orientation, the terms cannot be understood as the limitation of the present disclosure. In addition, the terms “first” and “second” are merely used for a purpose of description, and shall not be understood as an indication or implication of relative importance or implicit indication of the number of indicated technical features. Therefore, a feature limited by “first” or “second” may include one or more features explicitly or implicitly. In the description of the present disclosure, the meaning of “a plurality of” means two or more unless expressly specifically defined otherwise.

In the description of the present disclosure, it should be illustrated that, unless expressly specified and defined otherwise, the terms such as “install”, “communicate” and “connect” should be understood broadly, for example, the components can be fixedly connected, and also can be detachably connected or integrally connected; the components can be mechanically connected, and also can be electrically connected or in communication with one another; the components can be directly connected and also can be indirectly connected through an intermediate, and two components can be in communication internally or interact with each other. For those skilled in the art, the specific meanings of the terms in the present disclosure can be understood according to specific conditions.

In the present disclosure, unless expressly specified and defined otherwise, a first feature being “above” or “below” a second feature may include that the first feature and the second feature are in direct contact or that the first feature and the second feature are not in direct contact but are in contact through another feature between them. Moreover, the first feature being “over,” “above” and “upon” the second feature can be the first feature being directly above and obliquely above the second feature, or simply mean that the first feature is at a higher level than the second feature. The first feature being “under”, “below” and “underneath” the second feature can be the first feature being directly below and obliquely below the second feature, or simply mean that the first feature is at a smaller level than the second feature.

The following disclosure provides many different embodiments or examples for implementing different structures of the present disclosure. The components and arrangements of specific examples are described below in order to simplify the present disclosure. Of course, the components and arrangements are only examples, but are not intended to limit the present disclosure. Moreover, reference numbers and/or reference letters can be repeated in different examples in the present disclosure. This repetition is for the purposes of simplicity and clarity and does not dictate a relationship between the various embodiments and/or settings discussed. In addition, the present disclosure provides examples of various specific processes and materials, but those skilled in the art may realize the application of other processes and/or the use of other materials.

Preferred embodiments of the present disclosure are described below in combination with the attached figures, it should be understood that the preferred embodiments described herein are for illustration and explanation of the present disclosure only and are not intended to be limitation of the present disclosure.

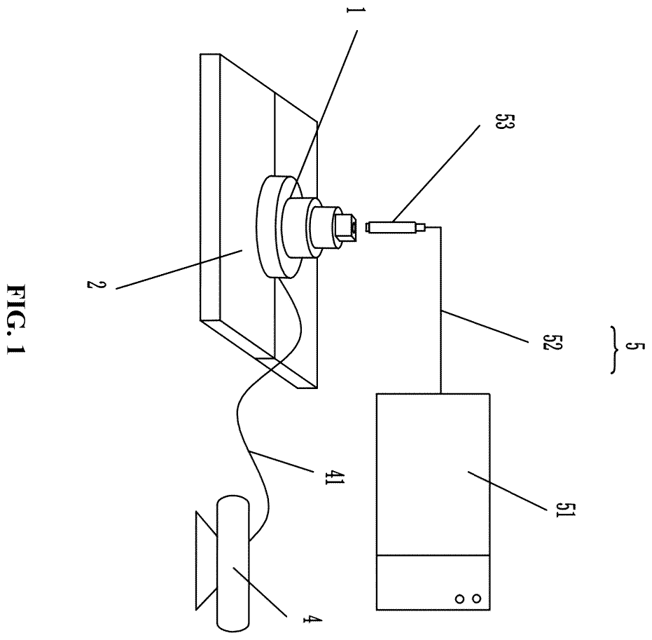

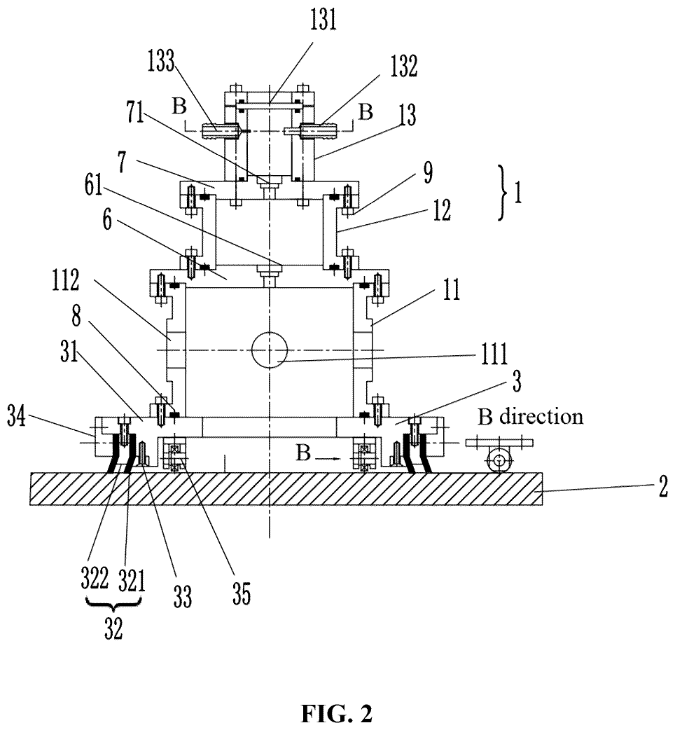

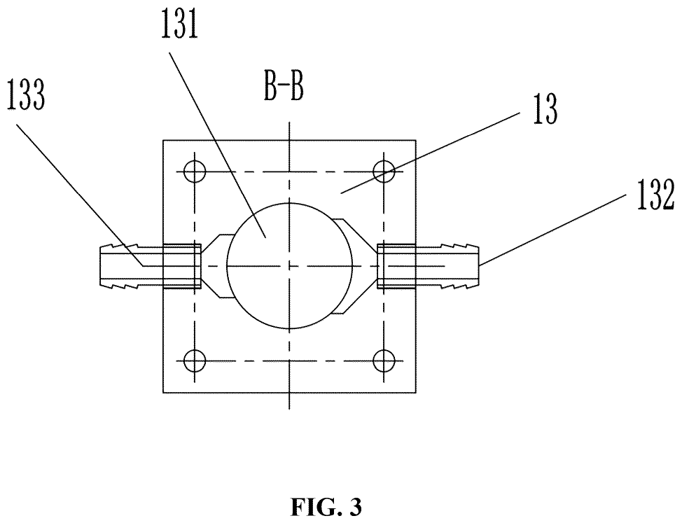

Referring to FIG. 1 to FIG. 5, the present disclosure provides a semi-closed local low-vacuum laser welding device. The semi-closed local low-vacuum laser welding device includes a local low-vacuum cabin 1, a dynamic sealing structure 3, a mechanical pump 4 and a laser welding mechanism. The local low-vacuum cabin 1 includes a primary vacuum chamber 11, a secondary vacuum chamber 12, and a tertiary vacuum chamber 13 which are arranged in sequence, and a plate to be welded 2 is arranged at a bottom of the primary vacuum chamber 11. The dynamic sealing structure 3 is arranged at the bottom of the primary vacuum chamber 11, and the dynamic sealing structure is configured for connecting the primary vacuum chamber 11 and the plate to be welded 2. The mechanical pump 4 is in communication with the primary vacuum chamber 11 and the secondary vacuum chamber 12. The laser welding mechanism is arranged corresponding to the local low-vacuum cabin 1, and is configured for welding the plate to be welded 2.

Through the arrangement of the mechanical pump 4, the connection between the mechanical pump 4 and the local low-vacuum cabin 1 is realized, so that the primary vacuum chamber 11, the secondary vacuum chamber 12, and the tertiary vacuum chamber 13 can be in a vacuum environment. Meanwhile, since the dynamic sealing structure 3 is arranged at the bottom of the vacuum chamber, the connection between the primary vacuum chamber 11 and the plate to be welded 2 is realized through the dynamic sealing structure 3. The plate to be welded 2 needs to be moved by a movement mechanism in the practical welding process, the plate to be welded 2 can be welded by a laser welding structure, therefore, the semi-closed welding of the local low-vacuum cabin 1 is realized.

The semi-closed local low-vacuum laser welding device combines the advantages of both laser welding and electron beam welding, and “vacuum environment” and “semi-closed welding” are combined to form a local vacuum structure, so that the size of components is no longer restricted by the vacuum chamber, while high-quality deep penetration welding of thick plate materials is realized.

The semi-closed local low-vacuum laser welding device is simple in structure, high in operability, and low in cost. Parts can be replaced in time when damaged. High-quality welding of large-size thick-walled components is realized at low cost.

The laser welding environment is changed from atmosphere to vacuum. It is found that laser welding in the vacuum environment can obtain high-quality weld seams similar to those during electron beam welding, and the vacuum degree of the vacuum environment required during the laser welding is much lower than that during electron beam welding, and no ray radiation is produced in the welding process, so that it is possible to form a local low-vacuum environment only in some areas of the welding position for laser welding. The local vacuum environment formed above the welding area can suppress the production of plasma/metal vapor groups, so that the welding defects are reduced, and the welding quality is improved. Furthermore, the size of a workpiece to be welded is no longer restricted by the volume of the vacuum chamber. Therefore, the exploration of semi-closed local vacuum laser welding equipment and welding method has important theoretical significance and practical value.

As a kind of clean energy, laser is high in energy utilization when applied in welding field, and the welding pollution is small, so unlike in arc welding, a few polluting smoke and dust is produced, and unlike in vacuum electron beam welding, no X-ray radiation is produced. The welding process is carried out in a semi-closed negative-pressure cabin, a part of metal vapor produced by welding is adhered to an inner surface of the negative-pressure cabin, part of metal vapor produced in welding is collected by the gas extraction device, and thus the metal vapor cannot diffuse into the air to cause pollution to the environment and damages to the health of welding personnel.

In some optional embodiments, the dynamic sealing structure 3 includes a base 31, a fixing plate 33 and a fixing ring 34. The base 31 is arranged at the bottom of the primary vacuum chamber 11, and a sealing element 32 is sleeved on the base 31. The fixing plate 33 is arranged on the base 31 and abuts against a side of the sealing element 32. The fixing ring 34 is sleeved on the base 31 and abuts against another side of the sealing element 32. The fixing ring 34 and the fixing plate 33 are configured for limiting a position of the sealing element 32.

Because the base 31 is arranged at the bottom of the vacuum chamber, a mounting position is provided for the installation of the sealing element 32. Furthermore, because the fixing plate 33 and the fixing ring 34 are arranged at both sides of the sealing element 32 on the base 31, and the fixing ring 34 is sleeved on an outer wall of the base 31, that is, the fixing ring 34 is arranged on an outer wall of the sealing element 32, to support the sealing element 32 from the outside, the fixing plate 33 is arranged on an inner wall of the sealing element 32 to support the sealing element 32 from the inside, the fixing ring 34 and the fixing plate 33 support the sealing element 32 from both sides of the sealing element 32, so that the sealing element 32 is prevented from shifting when the plate to be welded 2 is moved, and a vacuum environment between the vacuum chamber and the plate to be welded 2 is ensured.

A through hole is formed in the base 31, and the through hole is arranged to facilitate the laser of the laser welding mechanism to be irradiated on the plate to be welded 2.

In some optional embodiments, the sealing element 32 includes double sealing rings 321 and a fixing block 322. The double sealing rings 321 are arranged on the base 31. The fixing block 322 is located between the double sealing rings 321, and the fixing block 322 is configured for supporting the double sealing rings 321.

The arrangement of the double sealing rings 321 has the effect of double-layer sealing, and fully ensures that the local low-vacuum cabin 1 is always in a vacuum environment. Meanwhile, the fixing block 322 located between the double sealing rings 321 can effectively support the double sealing rings 321 between the double sealing rings 321. The fixing block 322, the fixing ring 34 and the fixing plate 33 together constitute a supporting structure for the double sealing rings 321, so that good dynamic sealing performance can still be maintained in the local low-vacuum cabin 1 during welding and moving.

In this embodiment, each of the double sealing rings 321 is a J-shaped sealing ring. The double sealing rings 321 are used, because the pressure inside the local low-vacuum cabin 1 is much lower than the external atmospheric pressure under working conditions, and this pressure difference enables the whole dynamic sealing structure 3 to realize self-locking function. The double sealing rings 321 realize multi-stage sealing to ensure the reliability of sealing.

Wherein, the fixing ring 34, the fixing plate 33, and the fixing block 322 are all fixedly connected to the base 31 through bolts 9.

In some optional embodiments, the dynamic sealing structure 3 further includes multiple supporting members 35, and the multiple supporting members 35 are arranged at intervals along a bottom of the base 31.

The supporting member 35 is a ball bearing, and the ball bearing is arranged at the bottom of the base 31 and abuts against the plate to be welded 2. The ball bearing can effectively support the base 31 and ensure the distance between the base 31 and the plate to be welded 2. The ball bearing and the sealing rings support the atmospheric pressure together, and the ball bearing shares most of the supporting force of the double sealing rings 321. The rolling friction force produced by the ball bearing under this part of supporting force is much smaller than that produced by the double sealing rings 321 alone. The rationality of this design lies in ensuring the flexibility and reliability of movement of the device on the premise of ensuring good sealing performance.

In some optional embodiments, the semi-closed local low-vacuum laser welding device further includes a primary deposition plate and a secondary deposition plate. The primary deposition plate is arranged between the primary vacuum chamber 11 and the secondary vacuum chamber 12, and a primary deposition hole is formed in the primary deposition plate. The secondary deposition plate is arranged between the secondary vacuum chamber 12 and the tertiary vacuum chamber 13, and a secondary deposition hole is formed in the secondary deposition plate.

The primary deposition plate is connected with the secondary vacuum chamber 12 through bolts 9, and an O-shaped sealing ring is arranged at the connection. The secondary deposition plate is connected with the tertiary vacuum chamber 13 through bolts 9, and an O-shaped sealing ring is also arranged at the connection.

The primary deposition hole in the primary deposition plate and the secondary deposition hole in the secondary deposition plate are convenient for the laser of the laser welding mechanism to pass through. Moreover, a diameter of an end of the primary deposition hole is larger than a diameter of another end of the primary deposition hole, and a diameter of an end of the secondary deposition hole is larger than a diameter of another end of the secondary deposition hole.

A laser beam is focused into an inverted cone through a lens 131, and the diameter of the primary deposition hole gradually decreases, so that the primary deposition hole is used to prevent most of the metal vapor particles and large particles from splashing during the welding process.

The secondary vacuum chamber 12 plays a role in separating the tertiary vacuum chamber 13 into which side-blown gas is introduced from the primary vacuum chamber 11 in which a welding task is carried out so as to prevent excessive blowing of gas from damaging the working vacuum degree.

The secondary deposition hole plays a role in intercepting the metal vapor particles that have not been blocked by the primary deposition plate. The side-blown gas for the tertiary vacuum chamber 13 is prevented from damaging the vacuum degree of the primary vacuum chamber 11.

In some optional embodiments, a gas extraction interface 11l is formed on the primary vacuum chamber 11, and the mechanical pump 4 is in communication with the gas extraction interface 111 through a gas extraction pipeline 41.

The primary vacuum chamber 11 is the main welding vacuum chamber, and includes the gas extraction interface 111 and observation windows 112 at both sides. The gas extraction interface 11l is connected with the gas extraction pipeline 41 to vacuum the cabin. The primary vacuum chamber 11 is connected with the dynamic sealing structure 3 through bolts 9 and sealed with the O-shaped sealing rings. The observation windows 112 at both sides can also be modified into electrical measuring flanges according to requirements, and are used for connecting vacuum gauges to monitor pressure in the cabin.

In some optional embodiments, the tertiary vacuum chamber 13 further includes a lens 131, a gas suction port 132 and a gas blowing port 133. The laser welding mechanism is arranged corresponding to the lens 131. The gas suction port 132 and the gas blowing port 133 are formed at both sides of the tertiary vacuum chamber 13, the gas suction port 132 is in communication with the mechanical pump 4 through the gas extraction pipeline 41, and the gas blowing port 133 is connected with an argon gas source.

The gas blowing port 133 is in communication with the argon gas source, and the gas suction port 132 is connected with the gas extraction pipeline 41. The gas suction port 133 is in a flat shape, and the size of the gas suction port 132 is slightly larger than that of the gas blowing port 133 in order to ensure the gas suction efficiency.

The laser is incident onto the welding area of the local low-vacuum cabin 1 through the lens 131, and a fixing hole of the lens 131 for fixing the lens 131 is formed in an inner wall of the tertiary vacuum chamber 13.

A circulating water cooling passage for cooling the lens 131 may further be arranged in the tertiary vacuum chamber 13 to prevent the temperature of the lens 131 from being too high to influence normal use of the lens 131.

In some optional embodiments, the laser welding mechanism includes a laser, a transmission fiber, and a laser processing head. The transmission fiber is configured for connecting the laser with the laser processing head. The laser processing head is arranged corresponding to the lens 131.

The laser is connected with the laser processing head through the transmission fiber, and the position of the laser processing head relative to the local low-vacuum cabin 1 is fixed by means of a stable support (not shown in the figure).

The overall height of the local low-vacuum cabin 1 is smaller than the focal length of the lens 131 at the head of a laser gun, so that the adjustment of defocusing parameter in various ranges can be adapted. The primary vacuum chamber 11, the secondary vacuum chamber 12, the tertiary vacuum chamber 13, the dynamic sealing structure 3, the primary deposition plate, and the secondary deposition plate are all made of aluminum material to ensure good heat dissipation, and small mass of the aluminum material is convenient for movement and installation.

The device can also be modified and added with a wire feeding device in a later stage to realize the additive manufacturing of laser fuse in a local vacuum environment, so that the forming quality and the performance of the formed parts are improved by means of a local negative pressure.

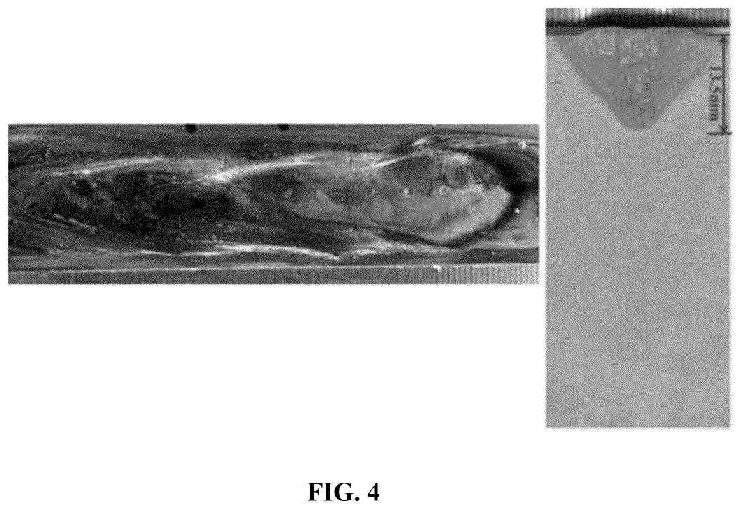

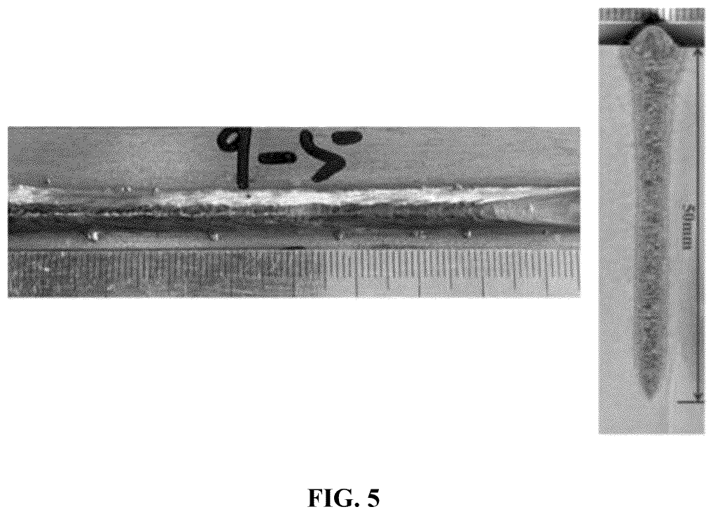

Referring to FIG. 4 and FIG. 5, FIG. 4 shows a penetration depth of 13.5 mm under an atmospheric environment (101 kPa), and FIG. 5 shows a penetration depth of 50 mm under a low-vacuum environment (100 Pa). It can be seen that under the same process conditions, the weld seams formed under the low-vacuum environment are smooth and uniform, and a larger welding penetration depth is obtained and is increased by about 1.5-3 times.

The present disclosure also provides a welding method of a semi-closed local low-vacuum laser welding device, including: the mechanical pump 4 is turned on to vacuum the local low-vacuum cabin 1 until environmental pressure is maintained to a required working pressure to realize dynamic balance; and the laser welding mechanism 5 is turned on, laser light is output to pass through the tertiary vacuum chamber 13, the secondary vacuum chamber 12 and the primary vacuum chamber 11 in sequence from a top of the local low-vacuum cabin 1, and apply on a plate to be welded 2 to form weld seams.

The specific welding method of the semi-closed local low-vacuum laser welding device includes: the local low-vacuum cabin 1 is placed on the plate to be welded 2. the laser is turned on to guide light to pass through a protective lens 131 and apply on the plate to be welded. The plate to be welded 2 is moved through a movement mechanism. The position of the local low-vacuum cabin 1 is adjusted so that a guiding light spot always coincides with an area to be welded. The stable support of the local low-vacuum cabin 1 is fixed. The position of the laser processing head is adjusted so that the position of the laser processing head relative to the low-vacuum cabin is fixed. The adjustment of welding trajectory is now finished.

Valves at a gas extraction pipeline 41 and a gas suction port 132 are opened, the gas blowing port 133 is opened, the circulating water cooling passage in the tertiary vacuum chamber 13 is opened. The mechanical pump 4 is turned on to vacuum the local low-vacuum cabin 1 until the environmental pressure is maintained to the required working pressure to achieve a dynamic equilibrium state. Meanwhile, the ball bearing in the dynamic sealing structure 3 and the double sealing rings 321 support the atmospheric pressure together, and the double sealing rings 321 realizes the sealing of the cabin; the ball bearing shares most of the supporting force of the double sealing rings 321, and the rolling friction produced by the ball bearing under this part of the supporting force is much smaller than that produced by the double sealing rings 321 alone, so that the flexibility and reliability of movement of the device can be ensured on the premise of ensuring good sealing performance.

The laser is turned on, and a laser beam is output to pass through the tertiary vacuum chamber 13, the secondary deposition hole, the secondary vacuum chamber 12, the primary deposition hole and the primary vacuum chamber 11 in sequence from the top of the lens 131, and apply on the plate to be welded 2. The movement mechanism is turned on to realize movement of the plate to be welded 2 relative to the local low-vacuum chamber 1.

After welding, the local low-vacuum chamber 1 is removed from the workpiece, thus the entire local low-vacuum laser processing process of the plate is finished.

Apparently, the embodiments are merely illustrative of the present disclosure as examples and are not intended to be limitation of embodiments of the present disclosure. For those skilled in the art, other variations or modifications in different forms may be made on the basis of the above description. All embodiments need not be exhaustive or otherwise impossible to be exhaustive herein. Obvious changes or variations of the embodiments are still fall within the scope of protection of the present disclosure.

1. A semi-closed local low-vacuum laser welding device, comprising:
a local low-vacuum cabin comprises a primary vacuum chamber, a secondary vacuum chamber, and a tertiary vacuum chamber which are arranged in sequence, a plate to be welded is arranged at a bottom of the primary vacuum chamber;
a dynamic sealing structure, the dynamic sealing structure is arranged at the bottom of the primary vacuum chamber, and the dynamic sealing structure is configured for connecting the primary vacuum chamber with the plate to be welded;
a mechanical pump, the mechanical pump is in communication with the primary vacuum chamber and the secondary vacuum chamber; and
a laser welding mechanism, the laser welding mechanism is arranged corresponding to the local low-vacuum cabin and configured for welding the plate to be welded.

2. The semi-closed local low-vacuum laser welding device according to claim 1, wherein the dynamic sealing structure comprises:
a base, the base is arranged at the bottom of the primary vacuum chamber, and a sealing element is sleeved on the base;
a fixing plate, the fixing plate is arranged on the base and abuts against a side of the sealing element; and
a fixing ring, the fixing ring is sleeved on the base and abuts against another side of the sealing element, and the fixing ring and the fixing plate are configured for limiting a moving position of the sealing element.

3. The semi-closed local low-vacuum laser welding device according to claim 2, wherein the sealing element comprises:
double sealing rings arranged on the base; and
a fixing block located between the double sealing rings, the fixing block is configured for supporting the double sealing rings.

4. The semi-closed local low-vacuum laser welding device according to claim 2, wherein the dynamic sealing structure further comprises a plurality of supporting members, and the plurality of supporting members are arranged at intervals along a bottom of the base.

5. The semi-closed local low-vacuum laser welding device according to claim 4, further comprising:
a primary deposition plate, the primary deposition plate is arranged between the primary vacuum chamber and the secondary vacuum chamber, and a primary deposition hole is formed in the primary deposition plate; and
a secondary deposition plate, the secondary deposition plate is arranged between the secondary vacuum chamber and the tertiary vacuum chamber, and a secondary deposition hole is formed in the secondary deposition plate.

6. The semi-closed local low-vacuum laser welding device according to claim 5, wherein a diameter of an end of the primary deposition hole is larger than a diameter of another end of the primary deposition hole, and a diameter of an end of the secondary deposition hole is larger than a diameter of another end of the secondary deposition hole.

7. The semi-closed local low-vacuum laser welding device according to claim 6, wherein a gas extraction interface is formed on the primary vacuum chamber, and the mechanical pump is in communication with the gas extraction interface.

8. The semi-closed local low-vacuum laser welding device according to claim 5, wherein the tertiary vacuum chamber further comprises:
a lens, the laser welding mechanism is arranged corresponding to the lens; and
a gas suction port and a gas blowing port, the gas suction port and the gas blowing port are formed at both sides of the tertiary vacuum chamber, the gas suction port is in communication with the mechanical pump through the gas extraction pipeline, and the gas blowing port is connected with an argon gas source.

9. The semi-closed local low-vacuum laser welding device according to claim 8, wherein the laser welding mechanism, a transmission fiber, and a laser processing head, the transmission fiber is configured for connecting the laser with the laser processing head, and the laser processing head is arranged corresponding to the lens.

10. A welding method using the semi-closed local low-vacuum laser welding device according to claim 1, comprising:
turning on the mechanical pump to vacuum the local low-vacuum cabin until an environmental pressure is maintained to a required working pressure to realize dynamic balance; and turning on the laser welding mechanism, outputting laser light to pass through the tertiary vacuum chamber, the secondary vacuum chamber and the primary vacuum chamber in sequence from a top of the local low-vacuum cabin, and apply on the plate to be welded to form weld seams.

11. The semi-closed local low-vacuum laser welding device according to claim 3, wherein the dynamic sealing structure further comprises a plurality of supporting members, and the plurality of supporting members are arranged at intervals along a bottom of the base.

12. The semi-closed local low-vacuum laser welding device according to claim 11, further comprising:
a primary deposition plate, the primary deposition plate is arranged between the primary vacuum chamber and the secondary vacuum chamber, and a primary deposition hole is formed in the primary deposition plate; and
a secondary deposition plate, the secondary deposition plate is arranged between the secondary vacuum chamber and the tertiary vacuum chamber, and a secondary deposition hole is formed in the secondary deposition plate.

13. The semi-closed local low-vacuum laser welding device according to claim 12, wherein a diameter of an end of the primary deposition hole is larger than a diameter of another end of the primary deposition hole, and a diameter of an end of the secondary deposition hole is larger than a diameter of another end of the secondary deposition hole.

14. The semi-closed local low-vacuum laser welding device according to claim 13, wherein a gas extraction interface is formed on the primary vacuum chamber, and the mechanical pump is in communication with the gas extraction interface through a gas extraction pipeline.

15. The semi-closed local low-vacuum laser welding device according to claim 6, wherein the tertiary vacuum chamber further comprises:
a lens, the laser welding mechanism is arranged corresponding to the lens; and
a gas suction port and a gas blowing port, the gas suction port and the gas blowing port are formed at both sides of the tertiary vacuum chamber, the gas suction port is in communication with the mechanical pump through the gas extraction pipeline, and the gas blowing port is connected with an argon gas source.

16. The semi-closed local low-vacuum laser welding device according to claim 7, wherein the tertiary vacuum chamber further comprises:
a lens, the laser welding mechanism is arranged corresponding to the lens; and
a gas suction port and a gas blowing port, the gas suction port and the gas blowing port are formed at both sides of the tertiary vacuum chamber, the gas suction port is in communication with the mechanical pump through the gas extraction pipeline, and the gas blowing port is connected with an argon gas source.

17. The welding method using the semi-closed local low-vacuum laser welding device according to claim 10, wherein the dynamic sealing structure comprises:
a base, the base is arranged at the bottom of the primary vacuum chamber, and a sealing element is sleeved on the base;
a fixing plate, the fixing plate is arranged on the base and abuts against a side of the sealing element; and
a fixing ring, the fixing ring is sleeved on the base and abuts against another side of the sealing element, and the fixing ring and the fixing plate are configured for limiting a moving position of the sealing element.

18. The welding method using the semi-closed local low-vacuum laser welding device according to claim 17, wherein the sealing element comprises:
double sealing rings arranged on the base; and
a fixing block located between the double sealing rings, the fixing block is configured for supporting the double sealing rings.

19. The welding method using the semi-closed local low-vacuum laser welding device according to claim 17, wherein the dynamic sealing structure further comprises a plurality of supporting members, and the plurality of supporting members are arranged at intervals along a bottom of the base.

20. The welding method using the semi-closed local low-vacuum laser welding device according to claim 18, wherein the dynamic sealing structure further comprises a plurality of supporting members, and the plurality of supporting members are arranged at intervals along a bottom of the base.
